(19) United States
(12) Patent Application Publication
(10) Pub. No.: US 2007/0227965 A1
(43) Pub. Date: Oct. 4, 2007

(54) Deformable strainer

(76) Inventor: Jo-Anne Simard, Laval (CA)

Correspondence Address: INVENTION QUEBEC INC., Suite 202, 8065, Boul. Viau, Montreal, QC, H1R 2T2, CA

(21) Appl. No.: 11/392,787

(22) Filed: Mar. 30, 2006

(51) Int. Cl. B01D 35/02

(52) U.S. Cl. 210/469; 210/470; 99/495

(57) ABSTRACT

A strainer mountable over the pouring aperture of a cooking vessel includes a straining plate having straining apertures extending therethrough. An attachment flange extends from the plate peripheral edge and defines a flange contacting surface for frictionally contacting the peripheral wall of the vessel so as to generate a frictional force therebetween. The straining plate is made out of a resiliently deformable material so as to allow the straining plate to be stretchable from an unstretched configuration to a stretched configuration. Upon the straining plate being stretched towards the plate stretched configuration, the resilient nature of the straining plate biases the straining plate towards the plate unstretched configuration for exerting a compressive force on the peripheral wall of the vessel and increasing the intensity of the frictional force.

### FIELD OF THE INVENTION

The present invention relates to the general field of food preparation implements and is particularly concerned with a deformable strainer.

### BACKGROUND OF THE INVENTION

There exists a plurality of situations wherein, in the preparation of food, it is desirable to separate or strain a liquid from a solid. For example, it is often desirable to drain cooking liquids such as water out of a cooking vessel in which a given food such as vegetables, pasta or the like has boiled or otherwise been cooked.

The conventional straining operation is typically performed using conventional strainers. These conventional strainers typically are substantially bowl or pot-shaped and may incorporate one or more features such as a single handle, a pair of handles or an extended handle and leg combination. These conventional strainers typically include drainage apertures that vary in number and size in proportion to the items to be strained. The volume of these conventional strainers also varies from small to large. The material of their construction also typically varies. Conventional strainers are, nowadays, typically made out of a polymeric resin although some strainers made out of aluminum, stainless steel or the like are also used.

During a typical straining operation, using a conventional strainer, the latter is placed in or held over a sink or a large bowl. A cooking vessel containing both food and the liquid to be strained is tilted sideways or upside down over the strainer and the food falls from the cooking vessel into the strainer. This tilting action is often considered unergonomical and can cause the user to drop the cooking vessel or its contents, especially as the weight of the cooking vessel shifts.

Also, if the cook transfers the food and liquid too quickly, the liquid may splash onto the cook's face or body, or onto the surrounding countertop and/or floor. In addition, the food itself may not fall directly from the cooking vessel into the strainer and may land in the sink, on the floor, or other undesired locations.

Furthermore, if the food has been boiled, hot steam typically rises from the cooking vessel. Hence, if boiling liquid is poured out of the cooking vessel, the cook's arms and hands may be exposed to the steam, potentially resulting in a burn injury.

Another problem associated with conventional strainers is the fact that such conventional strainers are not adapted to be used with various sizes of cooking vessels. When there is not a good fit between the strainer and the cooking vessel, the hereinabove-mentioned problems are compounded.

Accordingly, there exists a need for an improved cooking strainer.

### SUMMARY OF THE INVENTION

It is a general object of the present invention to provide an improved cooking strainer. In accordance with the present invention, there is provided a strainer for straining liquids being poured through a pouring aperture of a cooking vessel, the cooking vessel having a vessel base wall and a vessel peripheral wall extending from the vessel base wall, the vessel peripheral wall defining a peripheral wall upper edge substantially circumventing the pouring aperture and a peripheral wall outer surface; the strainer being releasably attachable to the peripheral wall outer surface; the strainer comprising: a straining plate extending substantially through a plate geometrical plane, the straining plate having a plate first surface, an opposed plate second surface and a plate peripheral edge; the straining plate having straining apertures extending therethrough; an attachment flange extending substantially from the plate peripheral edge, the attachment flange having a flange contacting surface for frictionally contacting a circumferential contacting portion of the vessel peripheral wall so as to generate a frictional force between the flange contacting surface and the contacting portion of the vessel peripheral wall; at least a stretchable portion of the straining plate being made out of a resiliently deformable plate material so as to allow the straining plate to be stretchable substantially in the plate geometrical plane from a plate unstretched configuration wherein the plate peripheral edge has a peripheral edge first dimension to a plate stretched configuration wherein the plate peripheral edge has a peripheral edge second dimension, the peripheral edge second dimension being greater than the peripheral edge first dimension; wherein upon the straining plate being stretched towards the plate stretched configuration, the resilient nature of the stretchable portion of the straining plate biases the straining plate towards the plate unstretched configuration for exerting a compressive force on the contacting portion of the vessel peripheral wall and increasing the intensity of the frictional force between the flange contacting surface and the contacting portion of the vessel peripheral wall. Typically, the stretchable portion of the straining plate extends substantially throughout the straining plate.

Conveniently, at least a resilient portion of the attachment flange is made out of a resiliently deformable flange material so as to allow at least a movable portion of the flange contacting surface to move substantially outwardly from a movable portion first position to a movable portion second position, the perimeter of the movable portion of the flange contacting surface being greater in the movable portion second position than in the movable portion first position, wherein upon the resilient portion of the attachment flange being deformed so as to move the movable portion of the flange contacting surface towards the movable portion second position, the resilient nature of the resilient portion of the attachment flange biases the movable portion of the attachment flange back towards the movable portion first position.

Typically, the resilient portion of the attachment flange extends substantially throughout the attachment flange. Conveniently, the movable portion of the flange contacting surface extends substantially throughout the flange contacting surface.

Typically, the flange contacting surface is provided with a circumferential contacting surface groove extending at least partially therealong, the flange contacting surface defining a contacting surface first portion extending from the contacting surface groove substantially towards the straining plate and an opposed contacting surface second portion extending from the contacting surface groove substantially away from the straining plate.

Conveniently, the contacting surface groove has a substantially U-shaped cross-sectional configuration, the nadir of the contacting surface groove being located substantially radially outwardly.

Typically, the straining plate and the attachment flange are both made out of an integral piece of resiliently deformable elastomeric material.

Conveniently, the strainer further comprises a strainer handle, the strainer handle being coupled to the attachment flange by a handle-to-attachment flange coupling.

Typically, the strainer handle, the handle-to-attachment flange coupling, the attachment flange and straining plate are all made out of an integral piece of resiliently deformable material.

In at least one embodiment of the invention, the staining plate is provided with a stirring aperture extending therethrough. In at least one embodiment of the invention, the straining plate is provided with a pouring aperture extending therethrough, the pouring aperture being located substantially adjacent the attachment flange. In at least one embodiment of the invention, the strainer is further provided with a pouring lip extending substantially outwardly from the straining plate.

Typically, the strainer is configured and sized such that upon a radial force being exerted on the strainer for stretching the strainer radially outwardly, the radial deformation of the straining plate is substantially greater than that of the attachment flange.

In accordance with the present invention, there is also provided, in combination, a cooking vessel and a strainer for straining liquids being poured through a pouring aperture of the cooking vessel, the cooking vessel having a vessel base wall and a vessel peripheral wall extending from the vessel base wall, the vessel peripheral wall defining a peripheral wall upper edge substantially circumventing the pouring aperture and a peripheral wall outer surface, the cooking vessel having a circumferential bead extending from the peripheral wall outer surface substantially adjacent the peripheral wall upper edge; the strainer being releasably attachable to the peripheral wall outer surface; the strainer comprising: a straining plate extending substantially through a plate geometrical plane, the straining plate having a plate first surface, an opposed plate second surface and a plate peripheral edge; the straining plate having straining apertures extending therethrough; an attachment flange extending substantially from the plate peripheral edge, the attachment flange having a flange contacting surface for frictionally contacting a circumferential contacting portion of the vessel peripheral wall so as to generate a frictional force between the flange contacting surface and the contacting portion of the vessel peripheral wall; the flange contacting surface being provided with a circumferential contacting surface groove, the contacting surface groove receiving the circumferential bead; at least a stretchable portion of the straining plate being made out of a resiliently deformable plate material so as to allow the straining plate to be stretchable substantially in the plate geometrical plane from a plate unstretched configuration wherein the plate peripheral edge has a peripheral edge first dimension to a plate stretched configuration wherein the plate peripheral edge has a peripheral edge second dimension, the peripheral edge second dimension being greater than the peripheral edge first dimension; wherein upon the straining plate being stretched towards the plate stretched configuration, the resilient nature of the stretchable portion of the straining plate biases the straining plate towards the plate unstretched configuration for exerting a compressive force on the contacting portion of the vessel peripheral wall and increasing the intensity of the frictional force between the flange contacting surface and the contacting portion of the vessel peripheral wall.

Advantages of the present invention include that the proposed cooking strainer is releasably mountable over the pouring aperture formed by conventional cooking vessels. The straining operation using the present invention hence only requires tipping of the cooking vessel with the proposed strainer mounted thereon without requiring the separate manipulation of a separate straining entity. The risk of injuries to the user and of creating a mess and/or wasting food is hence reduced.

The proposed cooking strainer is designed so as to be releasably secured over the pouring aperture of cooking containers in such a manner as to prevent involuntary removal thereof while the liquids are being poured from the cooking vessel and the solids retained therein.

The proposed cooking strainer is designed so as to be readily adaptable or adjustable to cooking vessels of various sizes. Furthermore, the proposed cooking strainer is designed so as to be substantially ergonomically attachable and detachable to and from a conventional cooking vessel without requiring manual dexterity or excessive strength.

Furthermore, the proposed cooking strainer is designed so as to be manufacturable using conventional forms of manufacturing and conventional materials through a relatively simple manufacturing process such as injection moulding so as to provide a cooking strainer that will be economically feasible, long-lasting and relatively trouble-free in operation.

In at least one embodiment of the present invention, the proposed cooking strainer is provided with strainer handles adapted to further secure the strainer to the cooking vessel and/or facilitate gripping of the cooking vessel handles.

Yet, still furthermore, in at least one embodiment of the invention, the cooking strainer is designed so as to allow insertion therethrough of various cooking implements such as stirring spoons, spatulas or the like in order to facilitate various cooking steps being performed as the food is being prepared without the need for removing the proposed cooking strainer from the cooking vessel.

Yet, still furthermore, in at least one embodiment of the invention, the proposed cooking strainer is further provided with a pouring spout in order to guide the flow of liquid as the liquid is being poured out from the cooking vessel.

### BRIEF DESCRIPTION OF THE DRAWINGS

Embodiments of the present invention will now be described, by way of example, with reference to the following drawings in which:

FIG. 1, in a partial perspective view with sections taken out, illustrates a strainer in accordance with an embodiment of the present invention, the strainer being shown mounted on a cooking vessel and used for pouring liquid out of the pouring vessel into a sink, the cooking vessel and sing being shown in phantom lines;

FIG. 2, in a perspective view, illustrates the strainer shown in FIG. 1;

FIG. 3, in a top view, illustrates the strainer shown in FIGS. 1 and 2;

FIG. 4, in an elevational view, illustrates the strainer shown in FIGS. 1 through 3;

FIG. 5, in a cross-sectional view taken along arrows 5-5 of FIG. 3, illustrates some of the configurational features of the strainer shown in FIG. 3;

FIG. 6, in a cross-sectional view, illustrates the strainer shown in FIGS. 1 through 5, about to be mounted to a conventional cooking vessel, the conventional cooking vessel being shown in phantom lines;

FIG. 7, in a cross-sectional view, illustrates the strainer shown in FIG. 6 mounted on the conventional cooking vessel also shown in FIG. 7, the conventional cooking vessel being shown in part and in phantom lines;

FIG. 8, in a cross-sectional view, illustrates the strainer shown in FIGS. 1 through 7 mounted on a larger cooking vessel than that shown in FIGS. 6 and 7, the larger cooking vessel being shown in part and in phantom lines;

FIG. 9, in a perspective view, illustrates a strainer in accordance with an alternative embodiment of the present invention;

FIG. 10, in a perspective view, illustrates a strainer in accordance with an alternative embodiment of the present invention.

### DETAILED DESCRIPTION

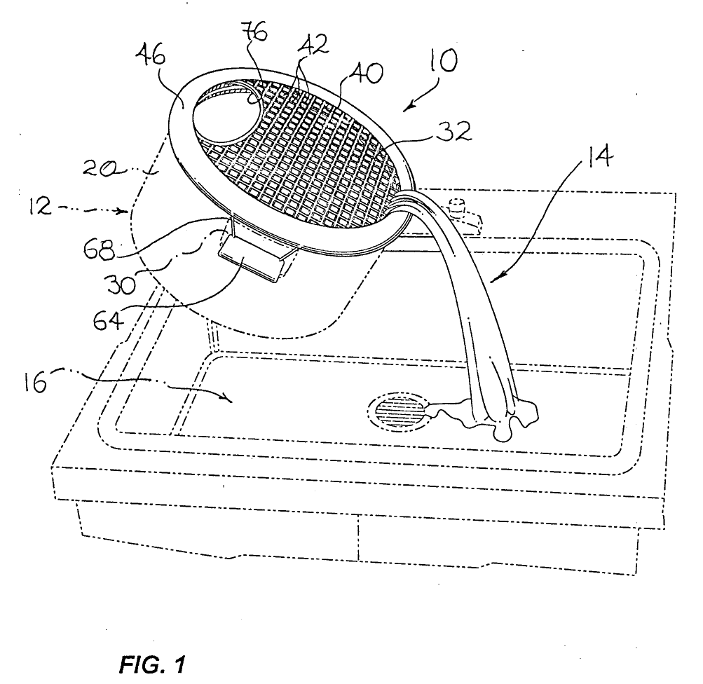

Referring to FIG. 1, there is shown a strainer in accordance with an embodiment of the present invention, generally indicated by the reference numeral 10. The strainer 10 is shown mounted on a conventional cooking vessel generally indicated by the reference numeral 12. It should be understood that although FIG. 1 illustrates the strainer 10 mounted, by way of example, on a conventional boiling pot-type cooking vessel, the strainer 10 could be used on any other suitable type of vessels including any other suitable cooking vessels such as pots, pans, or the like of various sizes and configurations without departing from the scope of the present invention.

In FIG. 1, the strainer 10 is shown straining a liquid from a solid. The liquid, generally indicated by the reference numeral 14, is shown being poured out of the cooking vessel 12 through the strainer 10 into a sink, generally indicated by the reference numeral 16. It should, however, be understood that the strainer 10 could be used in numerous other contexts for separating solids from liquids and pouring the liquid into any suitable receptacle or the like without departing from the scope of the present invention.

FIG. 6 will now be used to designate various sections or features of a conventional cooking vessel 12 usable with the strainer 10. Each cooking vessel 12 typically includes a vessel base wall 18 and a vessel peripheral wall 20 extending from the vessel base wall 18. The vessel peripheral wall 20 defines a peripheral wall outer surface 22. The vessel peripheral wall 20 also defines a peripheral wall upper edge 24 substantially circumventing a vessel pouring aperture 26.

The cooking vessel 12 may, in some instances, be provided with a vessel flange 28 extending typically radially outwardly from the peripheral wall outer surface 22. The vessel flange 28 may take any suitable form such as that of a rolled flange emanating from the peripheral wall upper edge 24. Typically, the vessel flange 28 is located substantially adjacent to the peripheral wall upper edge 24 although the vessel flange 28 may be spaced from the peripheral wall upper edge 24 in some instances.

It should be understood that the strainer 10, in accordance with the present invention, is adapted to be usable with cooking vessels having various types of vessel flanges 28 and with cooking vessels 12 deprived of any vessel flange.

The conventional cooking vessel 12 may also be provided with at least one and typically two vessel handles 30 extending typically substantially radially outwardly therefrom for facilitating the manipulation thereof. The vessel handles 30 may take any suitable form and size and be located at any suitable location. The strainer 10, in accordance with the present invention is adapted to be used with cooking vessels having any suitable type of vessel handles and with cooking vessels 12 deprived of any vessel handle.

As shown in cross-section in FIG. 5, the strainer 10 includes a straining plate 32 extending substantially through a plate geometrical plane 34. The straining plate 32 has a plate first surface 36, an opposed plate second surface 38 and a plate peripheral edge 40.

The straining plate 32 has a plurality of straining aperture 42 extending therethrough. The straining apertures 42 are shown throughout the Figures as having a substantially square-shaped configuration. It should, however, be understood that the straining apertures 32 could have any other suitable configuration without departing from the scope of the present invention. Also, throughout the Figures, the straining apertures 42 are shown as having an aperture bevelled peripheral edge 44. It should, however, be understood that the straining apertures 42 could be deprived of such straining aperture bevelled peripheral edge 44 without departing from the scope of the present invention.

The strainer 10 also includes an attachment flange generally indicated by the reference numeral 46. The attachment flange 46 extends substantially from the plate peripheral edge 40. The attachment flange 46 has a flange contacting surface generally indicated by the reference numeral 48 for frictionally contacting a circumferential contacting portion 50 of the vessel peripheral wall 20 so as to generate a frictional force between the flange contacting surface 48 and the contacting portion 50 of the vessel peripheral wall 20.

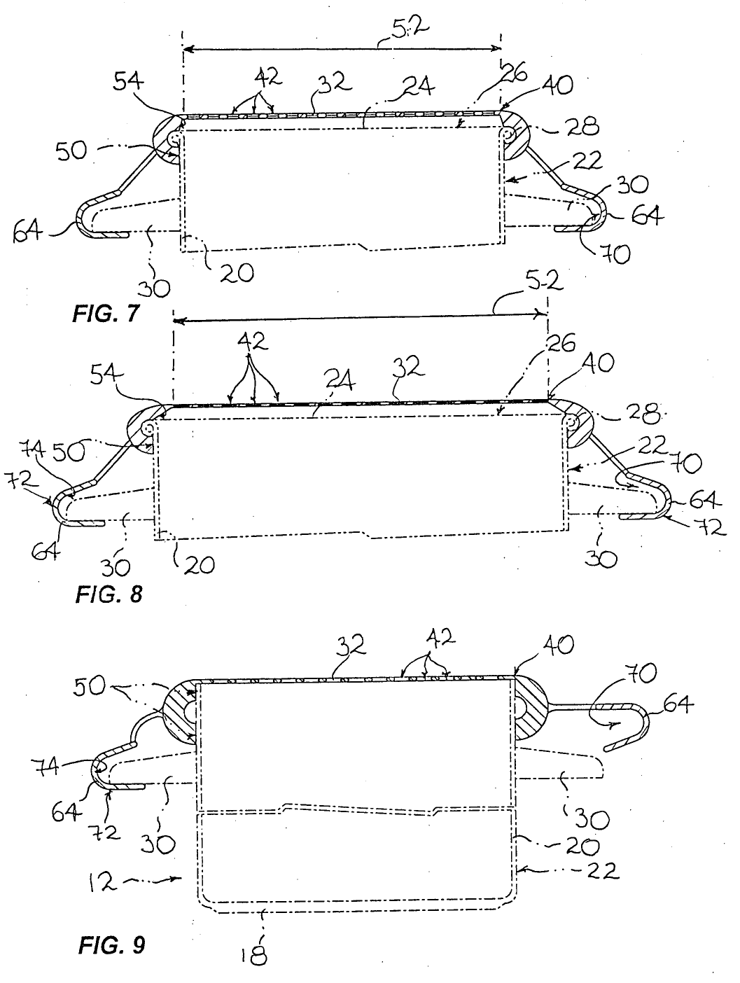

At least a stretchable portion of the straining plate 32 is made out of a substantially resiliently deformable plate material so as to allow the straining plate 32 to be stretchable substantially in the plate geometrical plate 34. The resiliently deformable plate material allows the straining plate 32 to be stretchable from a plate unstretched configuration, shown in FIG. 6 wherein the plate peripheral edge 40 has a peripheral edge first dimension to a plate stretched configuration, shown in FIG. 7, wherein the plate peripheral edge 40 has a peripheral edge second dimension, the peripheral edge second dimension being greater than the peripheral edge first dimension.

As shown throughout the drawings, the straining plate 32 typically has a substantially disc-shaped configuration. The straining plate 32 hence typically defines a plate diameter 52. The plate diameter 52 is smaller than the straining plate 32 is in the plate unstretched configuration than then the straining plate 32 is in the plate stretched configuration. By way of example, FIGS. 7 and 8 illustrate situations wherein the perimeter of the peripheral wall upper edge 24 of the respective illustrated vessels 12 is respectively smaller and greater and the corresponding increase in size of the plate diameter 52.

The resiliently deformable plate material is selected such that upon the straining plate 32 being stretched towards the plate stretched configuration, the resilient nature of the stretchable portion of the straining plate 32 biases the straining plate 32 towards the plate unstretched configuration for exerting a compressive force on the contacting portion 50 of the vessel peripheral wall 20 and increasing the intensity of the frictional force between the flange contacting surface 48 and the contacting portion 50 of the vessel peripheral wall 20.

Typically, in a preferred embodiment of the invention, the stretchable portion of the straining plate 32 extends substantially throughout the straining plate 32. It is, however, contemplated within the scope of the present invention to provide a straining plate 32 wherein only a limited portion thereof is stretchable. For example, in alternative embodiments of the invention, only a central portion of the straining plate 32 or a peripheral portion of the straining plate 32 could be made out of a resiliently stretchable material.

Typically, at least a resilient portion of the attachment flange 46 is made out of a resiliently deformable flange material. The resiliently deformable flange material allows at least a movable portion 44 of the flange contacting surface 48 to move substantially outwardly from a movable portion first position, for example illustrated in FIG. 6, to a movable portion second position, for example illustrated in FIGS. 7 and 8. The perimeter of the movable portion 44 of the flange contacting surface is typically greater in the movable portion second position than in the movable portion first position.

Upon the resilient portion of the attachment flange being deformed so as to move the movable portion of the flange contacting surface 48 towards the movable portion second position, the resilient nature of the resilient portion of the attachment flange 46 biases the movable portion of the attachment flange 46 back towards the movable portion first position.

Typically, the resilient portion of the attachment flange extends substantially throughout the attachment flange 46. Also, typically, the movable portion of the flange contacting surface 48 extends substantially throughout the flange contacting surface 48. It is, however, contemplated within the scope of the present invention that only a portion of the attachment flange 46 be of a resilient nature. It is also contemplated within the scope of the present invention that only a portion the flange contacting surface 48 be actually movable.

The flange contacting surface 48 is typically provided with a circumferential contacting surface groove 56 extending at least partially therealong. In the embodiment shown throughout the Figures, the contacting surface groove 56 extends uninterrupted circumferentially. It is, however, contemplated within the scope of the present invention that only a portion of the perimeter of the contacting surface be provided with a contacting surface groove or that the contacting surface groove be intermittent according to a predetermined interval pattern.

The flange contacting surface 48 defines a contacting surface, or first portion, 58 extending from the contacting surface groove 56 substantially towards the straining plate 32 and an opposed contacting surface second portion 60 extending from the contacting surface groove 56 substantially away from the straining plate 32.

In the embodiment shown throughout the Figures, the contacting surface first and second portions 58, 60 extend in a substantially common contacting surface geometrical plane 62. Also, the contacting surface geometrical plane 62 is shown extending in a direction substantially perpendicular to the plate geometrical plane 34. It is, however, contemplated within the scope of the present invention that the contacting surface first and second portions 58, 60 be in different geometrical planes and that such geometrical plates be in any suitable orientation relative to the plate geometrical plate 34.

FIGS. 7 and 8 illustrate situations wherein only the contacting surface second portion 60 actually frictionally contacts the contacting portion 50 of the vessel peripheral wall 20. FIG. 9 illustrates a situation wherein the vessel 12 is deprived of a vessel flange and wherein the contacting surface first and second portions 58, 60 contact a correspondingly shaped contacting portion 50 of the vessel peripheral wall 20.

Referring to FIG. 5, there is shown that typically, although by no means exclusively, the contacting surface groove 56 has a substantially U-shaped cross-sectional configuration. The nadir of the contacting surface groove 56 is typically located substantially radially outwardly. Typically, at least a resilient portion of the attachment flange 46 is deformable for reducing the size of the contacting surface groove 56. For example, when a smaller bead or vessel flange 28 is inserted into the contacting surface groove 56 without fitting the latter, stretching of the attachment flange 46 typically causes the size of the contacting surface groove 56 to be reduced so that the deformed contacting surface groove 56 substantially fittingly receives the smaller size bead or vessel flange 28.

Typically, the outer surface of the attachment flange 46 has a substantially rounded and convex configuration. It is, however, contemplated within the scope of the present invention that the outer surface of the attachment flange 46 be otherwise configured without departing from the scope of the present invention.

The strainer 10 typically further comprises at least one and preferably two strainer handles generally indicated by the reference numeral 64. Each strainer handle 64 is coupled to the attachment flange 46 by a corresponding handle-to-attachment flange coupling 66. Typically, the handle-to-attachment flange coupling 66 is resiliently deformable.

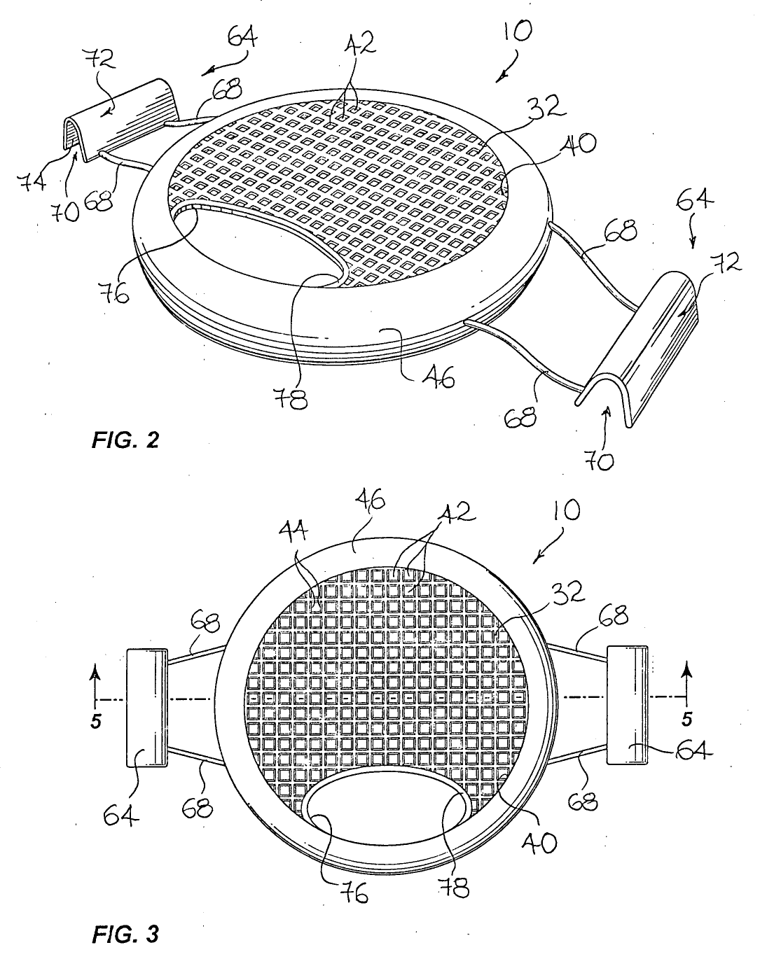

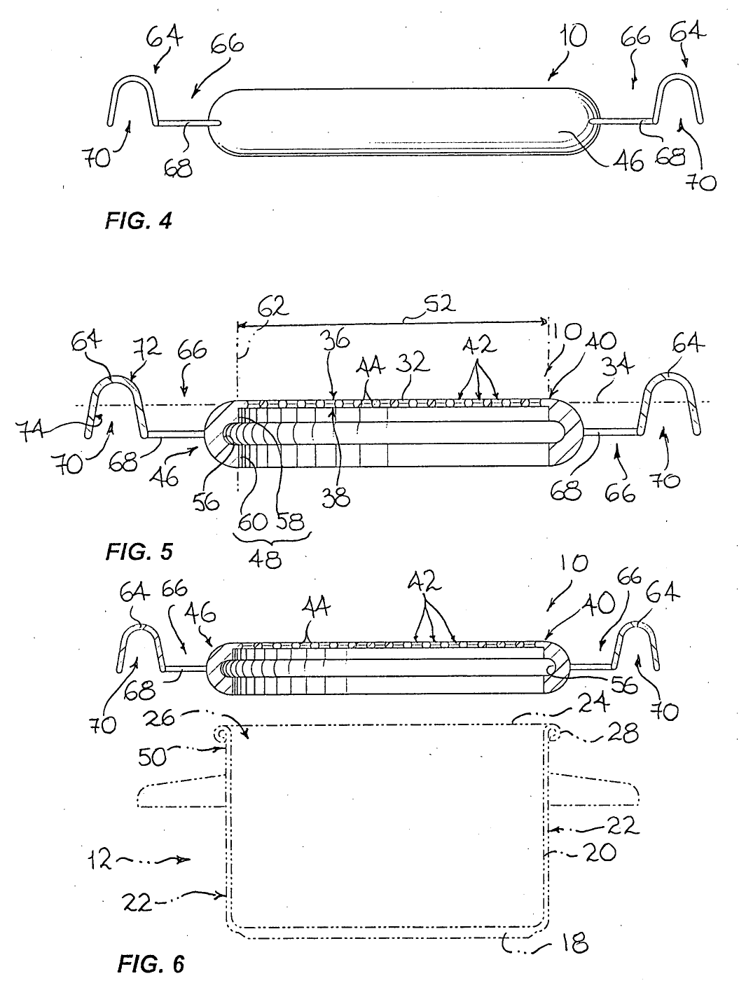

As shown more specifically in FIGS. 1-3 and 10, typically, each handle-to-attachment flange coupling 66 includes at least one and preferably a pair of generally elongated handle attachment members 68 extending between a corresponding handle 64 and the attachment flange 46.

Referring to FIG. 5, there is shown that, typically, at least one and preferably both strainer handles 64 have a substantially U-shaped cross-sectional configuration defining a handle cavity 70 for receiving a corresponding vessel handle 30.

Each strainer handle 64 has a handle-to-handle outer surface 72 for contacting a corresponding hand of an intended user and a handle-to-handle inner surface 74 for contacting a vessel handle 30.

As shown in FIGS. 1-3 and 10, the straining plate 32 is typically further provided with a stirring aperture 76 extending therethrough. The stirring aperture 76 is adapted to allow insertion therein of the stirring implements such as a stirring spoon, spatula or the like. Typically, the stirring aperture 76 is located substantially adjacent the attachment flange 46.

Typically, the stirring aperture 76 is at least partially circumvented by a stirring aperture rim 78. The stirring aperture rim 78 typically merges integrally about a section thereof with the attachment flange 46. Typically, although by no means exclusively, the stirring aperture 76 has a substantially oval configuration.

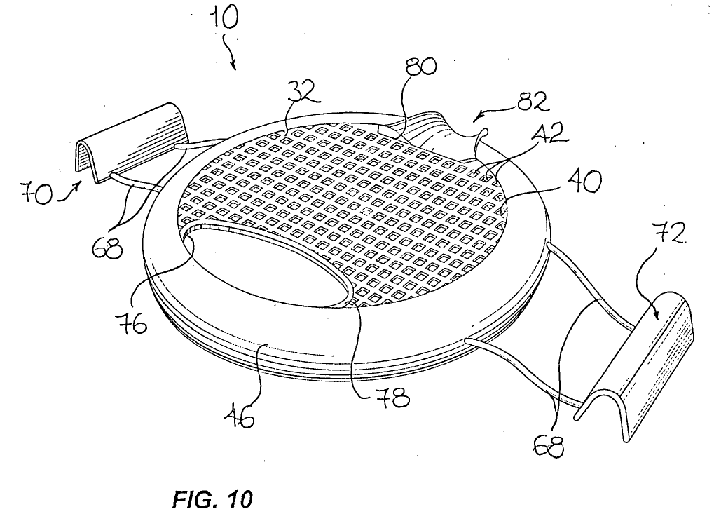

As illustrated more specifically in FIG. 10, the strainer 10 may optionally be further provided with a pouring aperture 80 extending therethrough. The pouring aperture 80 is typically located substantially adjacent the attachment flange 46.

Also, the strainer 10 may optionally be further provided with a pouring lip 82 extending substantially outwardly from the straining plate 32. The pouring lip 82 is adapted to be used for guiding the flow of liquid 14 being poured. Typically, the pouring lip 82 extends substantially from the plate peripheral edge 40, over the attachment flange 46 and radially outwardly therefrom. Typically, although by no means exclusively, the pouring lip 82 has a substantially radially convex and circumferentially concave configuration. Typically, the pouring lip 82 is in fluid communication with the pouring aperture 80.

When both the stirring aperture 76 and the pouring aperture 80 are provided, the stirring and pouring apertures 76, 80 are typically located in a substantially diametrically opposed relationship relative to each other.

Typically, the straining plate 32 and attachment flange 46 are both made out of an integral piece of resiliently deformable elastomeric material. For example, the straining plate 32 and attachment flange 46 may be made out of an integral piece of heat-resistant Silicon approved for use in the industry such as the product identified by the trade mark O-THANE® #RP 6400-1 manufactured by the company Ciba.

Typically, the strainer handle 64 and the handle-to-attachment flange coupling 66 are also made integrally with the attachment flange 46 and the straining plate 32 out of an integral piece of resiliently deformable material.

Typically, the difference in thickness between the thickness of the straining plate 32 and the attachment flange 46 combined with the configuration of the straining plate 32 and that of the attachment flange 46 is such that upon a radial force being exerted on the strainer 10 for stretching the strainer 10 radially outwardly, the radial deformation of the straining plate 32 is substantially greater than that of the attachment flange 46. This feature is adapted to facilitate mounting of the strainer 10 over the cooking vessel 12 and to reduce undue deformation of flange deformable section. Typically, the radial deformation of the straining plate 32 is in the range of square times the elongation of the attachment flange 46.

In use, a radial force is exerted by the intended user so as to stretch the strainer 10 radially outwardly for fitting the flange contacting surface 48 over the outer surface of the cooking container. The radial force is then released to allow the external surfaces to frictionally contact each other. The frictional contacts prevent unwanted removal of the strainer and also prevent the fluid from leaking between the flange and the cooking vessel.

The handles may be stretched so as to cover the cooking vessel handle acting as a further means for preventing unwanted removal of the strainer and also as a cover for facilitating the gripping of the cooking vessel handles.

1. A strainer for straining liquids being poured through a pouring aperture of a cooking vessel, said cooking vessel having a vessel base wall and a vessel peripheral wall extending from said vessel base wall, said vessel peripheral wall defining a peripheral wall upper edge substantially circumventing said pouring aperture and a peripheral wall outer surface; said strainer being releasably attachable to said peripheral wall outer surface; said strainer comprising:
a straining plate extending substantially through a plate geometrical plane, said straining plate having a plate first surface, an opposed plate second surface and a plate peripheral edge; said straining plate having straining apertures extending therethrough;
an attachment flange extending substantially from said plate peripheral edge, said attachment flange having a flange contacting surface for frictionally contacting a circumferential contacting portion of said vessel peripheral wall so as to generate a frictional force between said flange contacting surface and said contacting portion of said vessel peripheral wall;
at least a stretchable portion of said straining plate being made out of a resiliently deformable plate material so as to allow said straining plate to be stretchable substantially in said plate geometrical plane from a plate unstretched configuration wherein said plate peripheral edge has a peripheral edge first dimension to a plate stretched configuration wherein said plate peripheral edge has a peripheral edge second dimension, said peripheral edge second dimension being greater than said peripheral edge first dimension;
wherein upon said straining plate being stretched towards said plate stretched configuration, the resilient nature of said stretchable portion of said straining plate biases said straining plate towards said plate unstretched configuration for exerting a compressive force on said contacting portion of said vessel peripheral wall and increasing the intensity of said frictional force between said flange contacting surface and said contacting portion of said vessel peripheral wall.

2. A strainer as recited in claim 1, wherein said stretchable portion of said straining plate extends substantially throughout said straining plate.

3. A strainer as recited in claim 1, wherein at least a resilient portion of said attachment flange is made out of a resiliently deformable flange material so as to allow at least a movable portion of said flange contacting surface to move substantially outwardly from a movable portion first position to a movable portion second position, the perimeter of said movable portion of said flange contacting surface being greater in said movable portion second position than in said movable portion first position, wherein upon said resilient portion of said attachment flange being deformed so as to move said movable portion of said flange contacting surface towards said movable portion second position, the resilient nature of said resilient portion of said attachment flange biases said movable portion of said attachment flange back towards said movable portion first position.

4. A strainer as recited in claim 3, wherein said resilient portion of said attachment flange extends substantially throughout said attachment flange;

5. A strainer as recited in claim 3, wherein said movable portion of said flange contacting surface extends substantially throughout said flange contacting surface.

6. A strainer as recited in claim 1, wherein said flange contacting surface is provided with a circumferential contacting surface groove extending at least partially therealong, said flange contacting surface defining a contacting surface first portion extending from said contacting surface groove substantially towards said straining plate and an opposed contacting surface second portion extending from said contacting surface groove substantially away from said straining plate.

7. A strainer as recited in claim 6, wherein said contacting surface first and second portions extend in a substantially common contacting surface geometrical plane.

8. A strainer as recited in claim 7, wherein said contacting surface geometrical plane extends in a direction substantially perpendicular to said plate geometrical plane.

9. A strainer as recited in claim 6, where said contacting surface groove has a substantially U-shaped cross-sectional configuration, the nadir of said contacting surface groove being located substantially radially outwardly.

10. A strainer as recited in claim 9, wherein at least a resilient portion of said attachment flange is deformable for reducing the size of said contacting surface groove.

11. A strainer as recited in claim 1 wherein said straining plate and said attachment flange are both made out of an integral piece of resiliently deformable elastomeric material.

12. A strainer as recited in claim 1 wherein said straining plate and said attachment flange are both made out of an integral piece of Silicon.

13. A strainer as recited in claim 1, further comprising a strainer handle, said strainer handle being coupled to said attachment flange by a handle-to-attachment flange coupling.

14. A strainer as recited in claim 13, wherein said handle-to-attachment flange coupling is resiliently deformable.

15. A strainer as recited in claim 14 wherein said strainer handle, said handle-to-attachment flange coupling, said attachment flange and straining plate are all made out of an integral piece of resiliently deformable material.

16. A strainer as recited in claim 1 wherein said staining plate is provided with a stirring aperture extending therethrough.

17. A strainer as recited in claim 1 wherein said straining plate is provided with a pouring aperture extending therethrough, said pouring aperture being located substantially adjacent said attachment flange.

18. A strainer as recited in claim 17 wherein said strainer is further provided with a pouring lip extending substantially outwardly from said straining plate.

19. A strainer as recited in claim 1, wherein said strainer is configured and sized such that upon a radial force being exerted on said strainer for stretching said strainer radially outwardly, the radial deformation of said straining plate is substantially greater than that of said attachment flange.

20. In combination, a cooking vessel and a strainer for straining liquids being poured through a pouring aperture of said cooking vessel, said cooking vessel having a vessel base wall and a vessel peripheral wall extending from said vessel base wall, said vessel peripheral wall defining a peripheral wall upper edge substantially circumventing said pouring aperture and a peripheral wall outer surface, said cooking vessel having a circumferential bead extending from said peripheral wall outer surface substantially adjacent said peripheral wall upper edge; said strainer being releasably attachable to said peripheral wall outer surface; said strainer comprising:
a straining plate extending substantially through a plate geometrical plane, said straining plate having a plate first surface, an opposed plate second surface and a plate peripheral edge; said straining plate having straining apertures extending therethrough;
an attachment flange extending substantially from said plate peripheral edge, said attachment flange having a flange contacting surface for frictionally contacting a circumferential contacting portion of said vessel peripheral wall so as to generate a frictional force between said flange contacting surface and said contacting portion of said vessel peripheral wall;
said flange contacting surface being provided with a circumferential contacting surface groove, said contacting surface groove receiving said circumferential bead;
at least a stretchable portion of said straining plate being made out of a resiliently deformable plate material so as to allow said straining plate to be stretchable substantially in said plate geometrical plane from a plate unstretched configuration wherein said plate peripheral edge has a peripheral edge first dimension to a plate stretched configuration wherein said plate peripheral edge has a peripheral edge second dimension, said peripheral edge second dimension being greater than said peripheral edge first dimension;
wherein upon said straining plate being stretched towards said plate stretched configuration, the resilient nature of said stretchable portion of said straining plate biases said straining plate towards said plate unstretched configuration for exerting a compressive force on said contacting portion of said vessel peripheral wall and increasing the intensity of said frictional force between said flange contacting surface and said contacting portion of said vessel peripheral wall.
